(19) United States
(12) Patent Application Publication
(10) Pub. No.: US 2007/0116212 A1
(43) Pub. Date: May 24, 2007

(54) Dynamic call announcement using recipient identification

(75) Inventors: Xuedong D. Huang, Bellevue, WA (US); Kuansan Wang, Bellevue, WA (US); Jonathan Jay Cadiz, Redmond, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/246,492

(22) Filed: Oct. 7, 2005

(51) Int. Cl. H04M 11/00

(52) U.S. Cl. 379/93.03

(57) ABSTRACT

Call handling based on recipient identification is disclosed. Various embodiments, obtain, process and use recipient identification differently. Recipient identification includes obtaining data, information or vocalizations from a caller that indicate the person to whom the call in intended. One or more announcements relative to the call can be provided based on the data, information or vocalizations from the caller.

### BACKGROUND

Modern phone systems continue to be the dominant means of real-time communication between people. Telephones, whether based on old technology such as the plain old telephone system (POTS), or new technologies such as voice-over-ip, connect individuals together often spanning hundreds or thousands of miles.

Features such as caller identification (Caller ID) and voice-mail are no longer expensive options only available to select subscribers. Instead, these features are becoming so ubiquitous that it is somewhat alarming to attempt to call someone, and not hear their voice-mail message when the call goes unanswered. However, modern phone systems suffer from a number of limitations, which will be described below.

A typical household will have a single telephone number to service a number of family members. Typically, if no one is able to answer an incoming call, the family's voice-messaging system, whether provided by a physical answering machine located in the home, or as a service provided by the phone company, will answer the call and take a message. The saved message may also indicate the time of the call and provide saved caller-id information about the caller. A problem arises when someone who is not the intended call recipient is home and answers the call. The caller must then request that a message be taken and provided to the intended recipient. For example, a father may answer a call intended for one of his children, and then remember to give the message to the child. If he forgets, the message is lost. This situation is somewhat ameliorated with caller-id and distinctive ring technology. For example, when the father perceives that the incoming call, whether indicated by caller-id or a distinctive ring, is coming from a friend of the child, the father can allow the call to go unanswered if the child is not available. However, if the call originates from a shared outbound line, such as is common with businesses, the caller id information may simply indicate that the doctor is calling, without giving an indication of who from the doctor's office is calling, let alone who the intended recipient is. Again, the answerer must be trusted to relay the message to the intended recipient.

Recently, phone answering systems have provided the ability for unanswered calls to be routed to specific mailboxes for individual users. For example, the system may answer the call as follows, “I'm sorry, Jeff and Jill are not able to take your call. Press one to leave a message for Jeff; press two to leave a message for Jetty.” However, if Jeff or Jill is home, one of them may still inadvertently answer a call intended for the other. Thus the same problem as set forth above, still exists for systems that allow a caller to select individual voice-mail boxes.

Large corporations that have tens or hundreds of employees typically employ a switchboard to receive incoming calls and direct accordingly. Automated switchboards are also used where a caller is asked to select the desired employee from a listing of employees. More recently, such systems allow callers to say the name of the employee. The spoken name is then processed by the system and the call is transferred to the phone line of the employee whose name was spoken by the caller. Such systems are very complex and may require significant training and/or technician time for maintenance. However, the expense of such systems often borne by the businesses since it can reduce or eliminate the need for a human switchboard operator. Accordingly, such systems are typically limited to environments where an incoming main number can receive calls and transfer such calls among a vast number of employee phone lines.

The discussion above is merely provided for general background information and is not intended to be used as an aid in determining the scope of the claimed subject matter.

### SUMMARY

Call handling based on recipient identification is disclosed. Various embodiments, obtain, process and use recipient identification differently. Recipient identification includes obtaining data, information or vocalizations from a caller that indicate the person to whom the call in intended. One or more announcements relative to the call can be provided based on the data, information or vocalizations from the caller.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of one computing environment in which some embodiments may be practiced.

FIG. 2 is a diagrammatic view of a call handling system in accordance with one embodiment.

FIG. 3 is a block diagram indicating a call handling system having a speech processing engine in accordance with one embodiment.

FIG. 4 is a flow diagram of call processing in accordance with one embodiment.

FIG. 5 is a more detailed view of one method step illustrated in FIG. 4.

FIG. 6 is a more detailed view of another method step illustrated in FIG. 4.

FIG. 7 is a diagrammatic view of rule in accordance with one embodiment.

### DETAILED DESCRIPTION

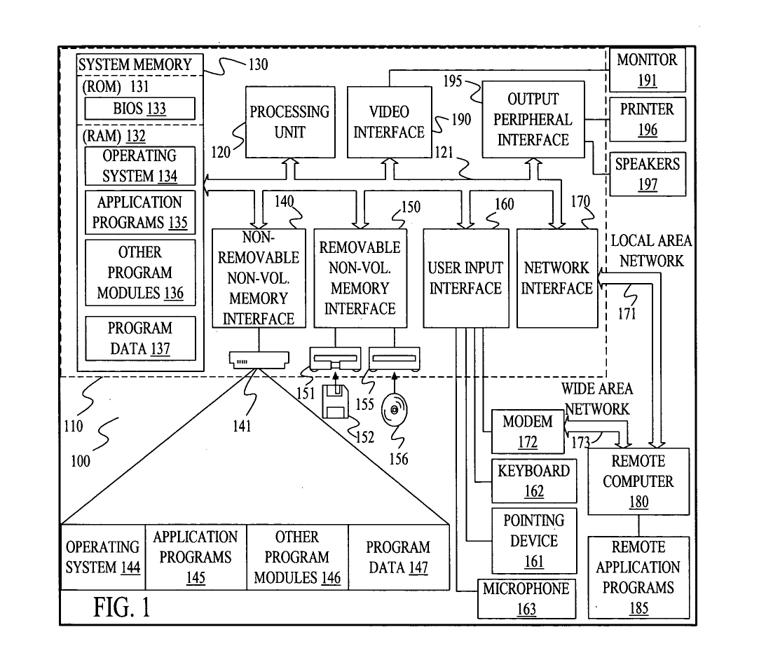

Embodiments can be practiced using a variety of call handling hardware environments. One particular environment, that of a personal computing system, is particularly advantageous due to its ubiquity. FIG. 1 illustrates an example of a suitable computing system environment 100 on which embodiments may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

One particular type of modem 172 is known as a phone modem and is generally adapted to couple computer 110 to a phone line. A phone modem provides computer 110 with the ability to operate the phone line. This allows computer 110 to cause the phone line to go off-hook when a call is arriving. Phone modems can also provide the analog signals from the phone line directly to circuitry within the modem, or computer 110. Moreover, in environments where the modem includes a dual-tone multi-frequency (DTMF) decoder, the computer system can react and/or respond to touch-tone keypresses by the caller. Such systems can be configured to provide the multiple voicemailbox systems described above.

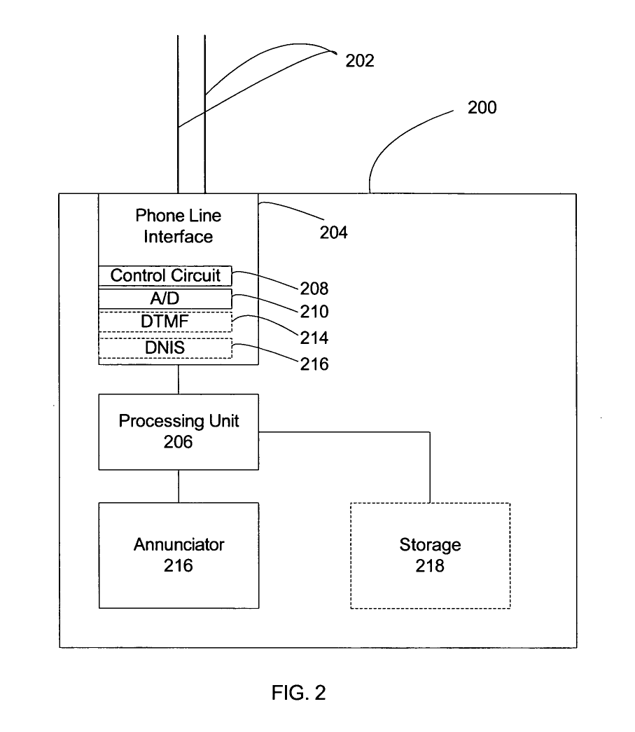

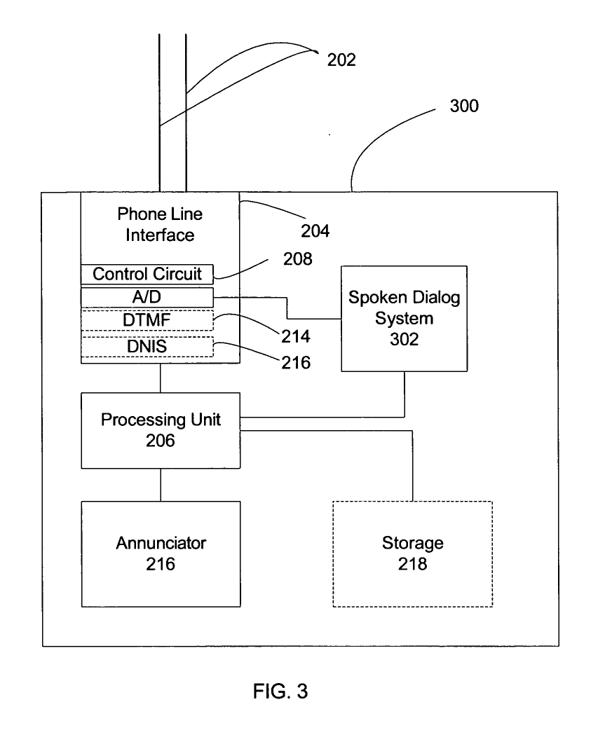

FIG. 2 is a simplified block diagram of a call handling system with which embodiments can be practiced. Those skilled in the art will recognize that the components illustrated within the apparatus shown in FIG. 2 can be found, or implemented, in a variety of devices, including computer 110 illustrated in FIG. 1. Moreover, system 200 and/or system 300 (illustrated in FIG. 3) can be a system located at a given phone line subscriber's premises, or it may be located remotely therefrom. For example, system 200 can be a remote server that hosts a service in accordance with various embodiments.

Call handling system 200 includes phone line interface 204 that couples system 200 to phone line 202. Interface 204 is coupled to processing unit 206, which may be or include processing unit 120 shown in FIG. 1. Interface 204 includes phone line control circuit 208 that allows interface 204 to engage or disengage phone line 202 based on one or more commands from processing unit 206. Interface 204 may also include analog-to-digital circuitry 210, which circuitry 210 is able to convert analog signals on received from the phone line into digital representations thereof. Note, analog-to-digital circuitry 210 need not be positioned physically within or even proximate phone line interface 204. Thus, analog-to-digital converter 210 may be provided by an attached sound card, or other suitable device, to which the analog signal(s) from the phone line is coupled. Optionally, phone line interface 204 includes or is coupled to a dual tone multi-frequency decoder 212, which allows system 200 to respond to touch-tone keypresses by a caller interacting with system over phone line 202. Examples of such interaction will be described later in the specification. Optionally, phone line interface 204 can include, or be coupled to, dialed number identification service (DNIS) module 214. Module 214 provides system 200 with information indicative of the phone number dialed by a caller. As with caller-id, DNIS service typically relies upon cooperation of a phone company to pass the data along. Ways in which DNIS can be used to practice embodiments will also be described later in the specification.

Various embodiments will generally be described with respect to the plain old telephone system (POTS). However, embodiments are expressly contemplated where different types of phones and phone systems are used, such as those that employ voice-over-ip technology. In such embodiments, phone line interface 204 is not include a phone line control circuit, but instead includes a software layer or module that obtains and decodes/encodes voice-over-ip packets received through a suitable network interface, such as network interface 170. Examples of such software modules or programs include MSN Messenger available from Microsoft Corporation of Redmond, Wash. Accordingly, as used herein, a phone call is intended to mean any two-way, substantially real-time communication between two or more people.

System 200 includes call annunciator or announcement module 216. Module 216 is coupled to processing unit 206 and provides announcements based on information received from processing unit 206. Examples of announcements include selective ring types and/or tones, visual displays such as lights or digital displays provided system 200. Such displays can be local to system 200, such as a liquid crystal display (LCD) screen disposed on system 200, or remote. Examples, of remote displays include displaying such announcements on a remote display such as a television, computer terminal, or a display on a cordless phone remote from system 200. Another remote announcement is in the form of messaging, such as through e-mail, short message service (SMS), or instant messaging (IM). Preferably system 200 also includes storage media 218. However, embodiments are also practicable where system 200 is operably coupled to storage media. Storage media 218 is useful for storing program instructions for processing unit 206 to execute in order to provide advanced call handling functions in accordance with various embodiments. Additionally, storage media 218 can also be used to store received call information for unanswered calls. Such information can include a voice message left by the caller as well as additional information such as the time of the call, any caller-id information, and any recipient-id information, in accordance with various embodiments.

Various embodiments make use of a new kind of call information; namely, recipient identification. Recipient identification is a process, method or technique by which an intended recipient of a phone call is automatically determined. While caller-id can sometimes be used to identify a caller's phone number, and sometimes name, recipient identification to a level of detail finer than the phone number itself has not been done. Thus, if location A has a phone line shared among a number of users, and location B has a phone line shared among a number of users, caller-id information indicating that a call ringing at location B originates from location A is of little value. Embodiments disclosed herein, however, can be used to obtain information about the person, or entity, that the caller is trying to reach. As set forth above, embodiments can be practiced using various types of hardware platforms. Further, there are various ways in which the recipient identification can be performed.

Recipient identification, as used herein, includes any method or technique by which a caller indicates, either while dialing or after connection, the intended recipient of the call. The manner in which the caller indicates the intended recipient can also vary considerably.

For example, the caller may dial a given phone number (ten digits with area code, or seven digits without area code) followed by an additional digit or digits indicative of a specific person located at the premises of the called number. For example, a father could be recipient number zero, the mother could be recipient number one, and a child could be recipient number two. A call to the family at (XXX-XXX-XXXX)-y can indicate, through DNIS service, that the call to the home at XXX-XXX-XXXX is directed to recipient y where y is an extra digit dialed by the caller.

Another way in which a caller can indicate recipient information is in response to a query from system 200. For example, phone line interface 204 can be configured to answer any incoming call immediately upon detection and audibly prompt the caller to indicate the intended recipient. The audible prompt can include a voice message such as, “The Smith family requests that you indicate the person to whom you are calling.” System 200 can then receive the caller's response in a number of ways. In one embodiment, the caller is prompted to select a recipient number corresponding to the intended recipient such as, “press one to direct this call to Jeff; press two to direct this call to Jill.” Then DTMF decoder 212 is employed to decode a touch-tone response of the caller indicative of the intended recipient. In another embodiment, the caller may simply be prompted to, “Please say the name of the person you are calling.” The caller's verbal reply is then stored and passed to annunciator module 216 where a speaker, for example, plays the stored reply aloud. If that person is available, they could take the call. If however, the requested person does not take the call within a selected time period, system 200 can interact with the caller to take a message.

In yet another embodiment, the caller's verbal reply is processed by a spoken dialog system to determine the intended recipient based on the caller's utterance. FIG. 3 is a block diagram indicating a call handling system having a spoken dialog system in accordance with one embodiment. System 300 bears many similarities to system 200 and like components are numbered similarly. System 300 differs from system 200 in that system 300 includes spoken dialog system 302. Spoken dialog system 302 can be embodied in hardware, software, or a combination of the two. Moreover, the illustration of system 302 being separate from processing unit 206 is simply for clarity, since system 302 may employ unit 206 for speech processing. Spoken dialog system 302 is any module or device that is able to audibly interact with a caller. System 302 can include speech recognition technology allowing it to receive an utterance, or a representation thereof, and provide a numerical or textual output that is an approximation of the spoken utterance. System 302 can employ any suitable speech recognition technology now known, or later developed. System 302 receives the caller's verbal reply, or a representation thereof, to the audible system request for the caller to identify the intended recipient. System 302 processes the utterance to generate data indicative of the intended recipient. Preferably, call handling system 300 can be programmed, or set up, to know whom the possible recipients at the premises are. Then, the speech recognition matching performed by spoken dialog system 302 can be tailored to only attempt to match within the pre-configured possible recipients. This way, speech recognition accuracy may be enhanced given the limited search domain.

Once the intended recipient is determined system 300 notifies the occupants or users at the dialed premises that an incoming call is waiting and the person to whom it is intended. This notification or announcement can also provide caller-id information if it is available. Thus, system 200 or 300 may announce, “Incoming call from 612-123-4567 for Jeff.” This announcement can generated as an audible announcement emanating from the call handling system itself, or it can be played from any other suitable devices such as a television, computer, or a public address announcement system. The announcement can also be visually displayed, such as on the call handling system itself, or on an external device. Moreover, the multi-modal announcements are also possible where one piece of information, such as caller-id is provided in one manner, such as on a display, while another piece of information, such as recipient-id, is announced as a custom ring-tone.

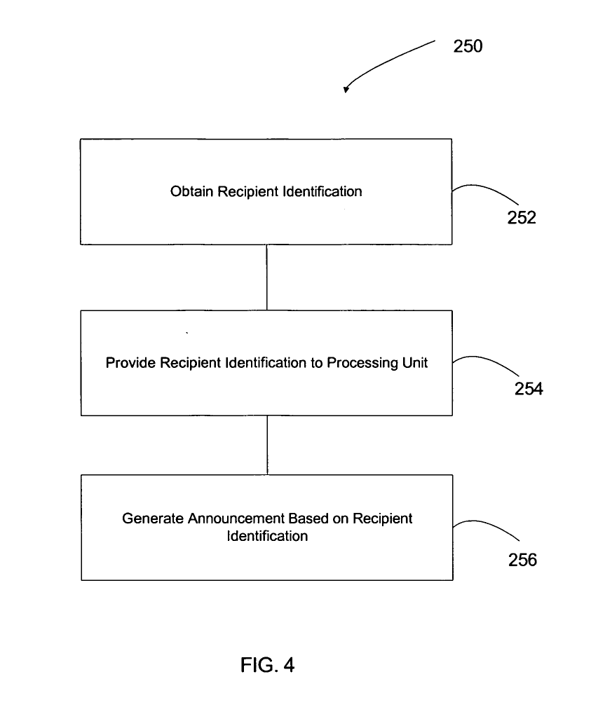

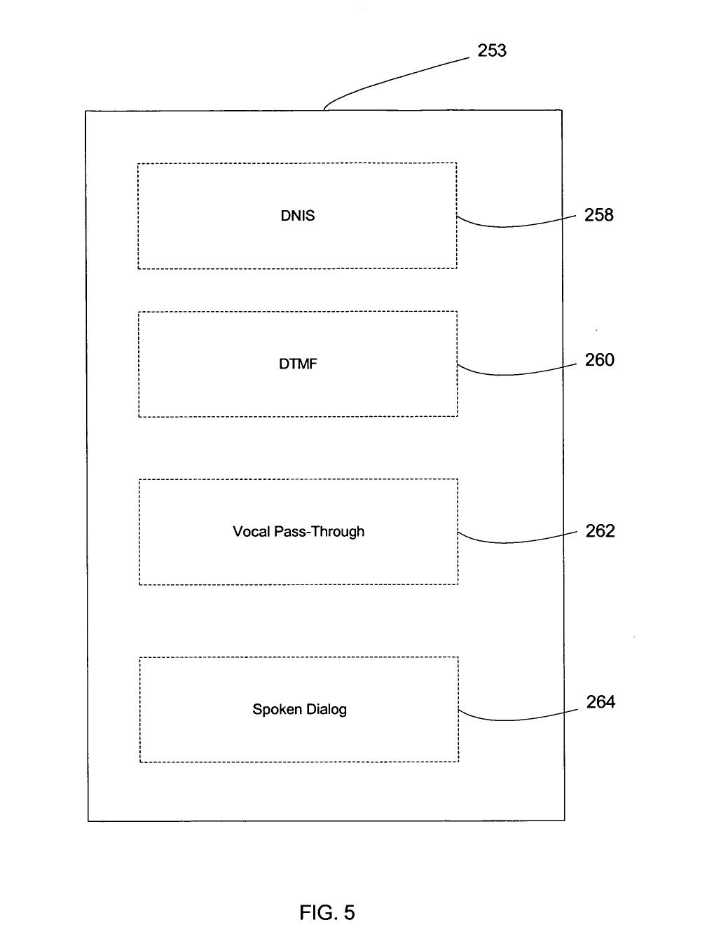

FIG. 4 is a flow diagram of a method of handling a call in accordance with one embodiment. Method 250 begins at block 252 where recipient identification information is obtained. FIG. 5 is a more detailed view of method step 252, and illustrates a number of ways in which such recipient information can be obtained. Specifically, step 252 can be effected as indicated at block 258 using DNIS. In this instance, the caller dials at least one extra number than is required to connect the call through the phone system. Using DNIS, and a DNIS decoder module 216, the call handling system determines the extra digit(s) accesses a pre-configured mapping between values for the extra digit(s) and recipients, thereby obtaining the intended recipient information.

As indicated at block 260 in FIG. 5, the intended recipient information can also be obtained by causing the call handling system to actually answer the call and prompt the caller to enter a touch-tone key indicative of the intended recipient. Using a DTMF decoder, such as decoder 214, the call handling system determines the number(s) pressed by the caller in response to the prompt. The call handling system then accesses a mapping between decoded digit(s) and recipients to convert the decoded digit(s) to recipient identification information.

As indicated at block 262, method step 252 can be effected simply by providing vocal pass-through. In this embodiment, the call handling system actually answers the call, and then audibly prompts the caller to say the name of the intended call recipient. The call handling system records the callers response and provides the response as an audible call annunciation or announcement. An example of this would be caller A attempting to contact recipient B among possible recipients B, C, and D at premises X. When caller A dials the call, the phone handling system at premises X answers the call prompts, “You have reached the X residence, please say whom you are calling.” The phone handling system then records caller A's response and generates an audible announcement within premises X, such as, “Incoming call for [B].” Where [B] is actually the stored response of caller A. If C and D hear the announcement, they will know that they need not take the call since it is not intended for them.

Method step 252 can also be done using a spoken dialog system as indicated at block 264. In this embodiment, the call handling system answers the incoming call and prompts the caller to say the name of the intended recipient of the call. The caller's response is then processed by the spoken dialog system to determine the intended recipient from the spoken utterance. Preferably, the spoken dialog system is provided with a listing of possible intended recipients available at the premises, such that speech recognition matching algorithms can be guided, or otherwise influenced, by possible matches. Accordingly, if the available recipients are Jeff and Jill, a caller whose voice is not clearly heard may utter something that sounds to the call handling system to be “Bill.” However, if the call handling system knows that the only available matches are Jeff and Jill, it is more likely to match the utterance to Jill given the phonetic similarities and the fact that “Bill” is not an available output.

Referring back to FIG. 4, once the recipient identification information is obtained at method step 252, it is provided to a processing unit, such as unit 206, as indicated at block 254. The processing unit then generates one or more annunciations or announcements based on the recipient identification information, as indicated at block 256. The announcement(s) generated by the processing unit can take many forms, and can vary based on various factors such as the recipient identification, caller-identification, time of day, et cetera.

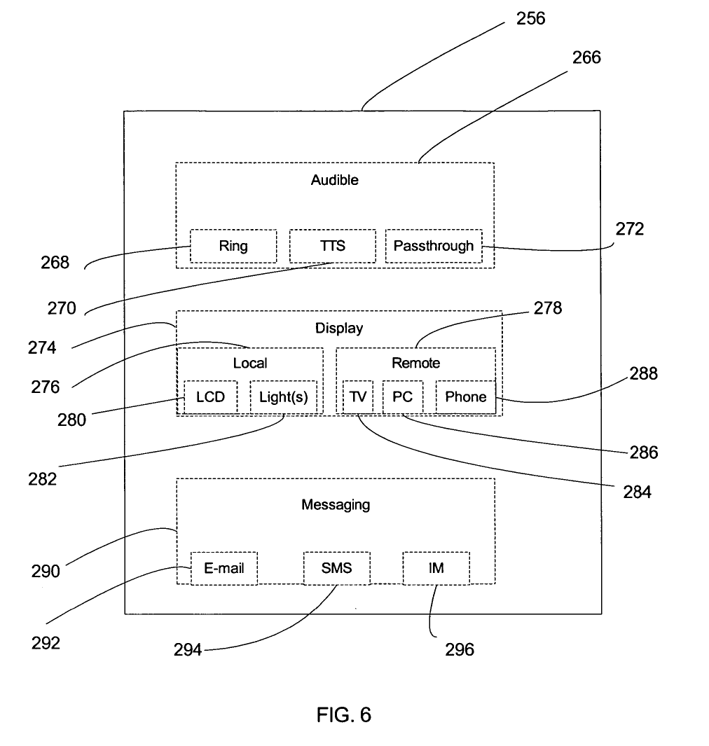

FIG. 6 is a more detailed view of method step 256 showing various types of announcements that can be generated during step 256. As indicated in FIG. 6, announcements can take various forms including audible announcements 266, visual announcements 274, and messaging announcements 290. Moreover, various combinations of any of the announcements can also be provided. Further still, one form of announcement can be employed to provide recipient identification information, while another form of announcement could be employed to provide other useful call information, such as caller-id information.

Audible announcement 266 includes varying characteristics of the ring. Such characteristics include ring tone, ring volume, and ring duration before passing the call to voice messaging system. Audible announcement 266 also includes employing known text-to-speech (TTS) technology 270 to automatically generate human speech indicative of the announcement. Audible announcement 266 can also include passthrough audio 272 such as the caller's recorded response to the call handling system's query regarding the intended recipient.

Visual, or display, announcement 274 includes local display 276 and/or remote display 278. Local display 276 is any display that is physically located at or on the call handling system. Such local displays 276 include digital displays, such as using liquid crystal display 280. Another type of local display is any light or lights 282 on the call handling system. For example, a light may flash or shine one color to one intended recipient and shine a different color or flash pattern to indicate a different intended recipient.

Visual, or display, announcement 274 can also include remote announcement 278. Examples of remote announcement include causing the call handling system to generate one or more displays on devices other than the call handling system. For example, if the call handling system is coupled to a television 284, such as when the call handling system is embodied within a set top box, the call handling system causes television 284 to display the recipient identification information. Remote announcement also includes causing one or more computing devices 286 that are operably coupled to the call handling system, such as through a wired or wireless LAN, to generate a display indicative of the intended recipient. Further, remote visual announcement also includes causing one or more telephones 288 to display the recipient identification information on their display. Many commercially available telephones, cordless or otherwise, have small screens that are often used to display caller-id information. Such screens would be suitable remote displays for recipient identification information in accordance with various embodiments.

The announcement generated at block 256 can also include a messaging announcement 290. Messaging announcements can include all or some of email messaging 292, short message service (SMS) messaging 294 and instant messaging (IM) 296.

As set forth above, there are a wide variety of announcements that can be used in accordance with various embodiments. In accordance with one embodiment, one or more rules are created and processed by the processing unit to generate customizable announcements, or other suitable actions. A rule generally includes one or more conditions upon which the rule will act, and one or more actions that will result when the rule fires. Examples of information that can be used to trigger, or otherwise engage, a rule include recipient identification information; caller-identification information; time of day; day of the week; DNIS information beyond that which may identify an intended recipient. Additionally, information created by a given user or recipient can also be used for rule conditions. Examples of such information include that the intended recipient is unavailable and/or a reason for unavailability, including being in a meeting, being out of town, et cetera. Examples of actions that can be generated when a rule fires include: generating one or more specific announcement(s); causing the call handling system to interact with the caller in a particular way, such as taking a voice-mail message, or urging the caller to call a different number, such as the cell phone number of the intended recipient.

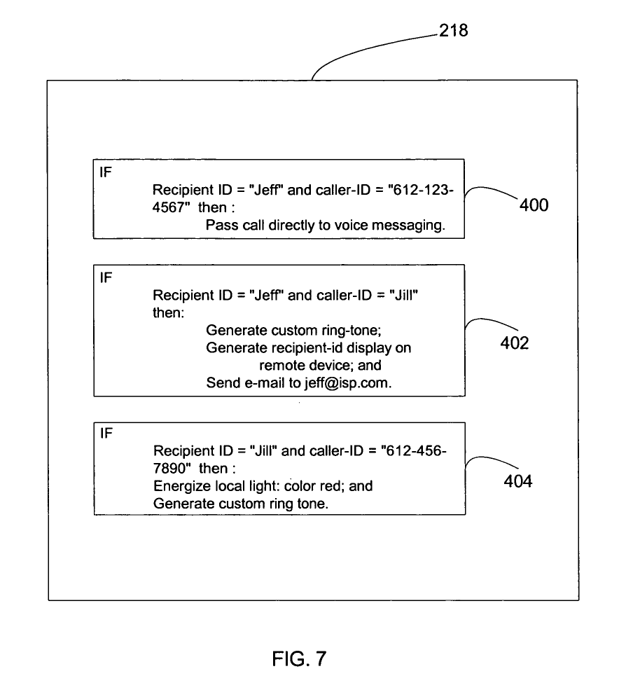

FIG. 7 is a diagrammatic view of rule in accordance with one embodiment. FIG. 7 illustrates rules 400, 402 and 404 stored within storage media 218. Rules conditions are preferably checked by a processing unit, such as processing unit 206, with each incoming call at method step 254 (FIG. 4). While all of the rules illustrated in FIG. 7 include two conditions, embodiments can be practiced using any suitable number of conditions including one. Rule 400 includes two conditions such that it will fire if and only if the recipient identification information indicates that the call is intended for “Jeff” and that caller-id information indicates that the call is originated by phone number 612-123-4567. In this embodiment, no announcement is provided and the call is passed directly to voice messaging. This rule may be beneficial if the Jeff typically receives many unwanted commercial solicitations from callers at 612-123-4567.

Rule 402 includes a pair of conditions that cause rule 402 to fire if and only if the recipient identification information is “Jeff” and the caller-id information indicates “Jill.” When rule 402 fires it generates a number of actions. Rule 402 causes processing unit 206 to generate a custom ring tone. It should be noted, that the custom ring tone can be specific to the recipient id-caller id combination. Thus, a call originating from Jill, as indicated by caller-id, and directed to someone else would generate a different ring tone. Rule 402 also causes a remote device, such as a television, to generate a visual indication of the call. The indication may be as simple as a message overlaying the television's display indicating,” Incoming call for Jeff from Jill.” Finally, rule 402 also causes processing unit 402 to generate an e-mail addressed to jeff@sisp.com. Thus, if Jeff is not home, he will still get an e-mail indicating that a call was intended for him.

Rule 404 executes when recipient identification information indicates that Jill is the intended recipient and the caller-id equals 612-456-7890. When this occurs, rule 404 causes processing unit 206 to cause a light on the call handling system to illuminate red, and to generate a custom ring tone.

Various embodiments disclosed herein provide a variety of new functions available to both callers and user of call handling systems. As stated above, embodiments can be practiced using a variety of hardware platforms. Further, embodiments can be practiced using a variety of different mechanisms for obtaining recipient identification. Further still, embodiments can provide a vast number of announcement types and combinations thereof. Finally, custom rules can allow significantly different call system behavior depending on a variety of conditions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A call handling system comprising:
a phone line interface;
a processing unit operably coupled to the phone line interface; and
wherein the processing unit is configured to obtain information indicative of an intended recipient of an incoming call and selectively generate an announcement based at least in part on the intended recipient.

2. The system of claim 1, wherein the announcement is an audible announcement.

3. The system of claim 1, wherein the announcement is a visual announcement.

4. The system of claim 1, wherein the announcement is a multi-modal announcement.

5. The system of claim 1, wherein the call handling system is embodied on a computer that is a server located remotely from the intended recipient.

6. The system of claim 1, and further comprising a spoken dialog system configured to receive a spoken utterance from a caller and generate the information indicative of the intended recipient from processing the spoken utterance.

7. An automated computer-implemented method of handling an incoming phone call, the method comprising:
automatically obtaining information indicative of an intended recipient of the incoming phone call; and
selectively generating an announcement based on the information indicative of the intended recipient.

8. The method of claim 7, wherein selectively generating an announcement includes not generating any announcement.

9. The method of claim 7, wherein automatically obtaining information indicative of the intended recipient includes obtaining dialed number information service (DNIS) information from the caller.

10. The method of claim 7, wherein automatically obtaining information indicative includes:
answering the incoming phone call with an automatic call handling system;
prompting the caller to indicate an intended recipient of the incoming phone call; and
receiving a response from the caller.

11. The method of claim 10, wherein the response is a dual tone multi-frequency (DTMF) response.

12. The method of claim 10, wherein the response is a verbal reply from the caller.

13. The method of claim 12, and further comprising providing the verbal reply to a spoken dialog system.

14. The method of claim 13, wherein the speech recognition of the spoken dialog system is constrained by data indicative of all possible intended recipients.

15. The method of claim 12, wherein the response is recorded and played as the announcement.

16. The method of claim 7, wherein selectively generating an announcement includes generating a plurality of announcements.

17. The method of claim 16, wherein at least one announcement is indicative of recipient identification, and at least one announcement is indicative of caller-identification information.

18. The method of claim 7, wherein selectively generating an announcement includes processing at least one rule to determine if a condition of the at least one rule is satisfied by the incoming phone call.

19. A computer readable medium having instructions thereon which when executed by a computer cause the computer automatically process calls, the instructions comprising:
instructions for answering an incoming phone call;
instructions for causing the computer to prompt the caller to indicate an intended recipient for the incoming phone call; and
instructions for selectively generating an announcement based on the caller's response.

20. The computer readable medium of claim 19, and further comprising instructions for processing the caller's response using a spoken dialog system to determine the intended recipient.
